(19) United States
(12) Patent Application Publication
(10) Pub. No.: US 2026/0243011 A1
(43) Pub. Date: Aug. 20, 2026

(54) HOT STEAM GENERATOR AND SYSTEM FOR PRINTING A SUBSTRATE

(71) Applicant: CANON KABUSHIKI KAISHA, Tokyo (JP)

(72) Inventor: Joachim Samweber, Eichenau (DE)

(21) Appl. No.: 19/540,240

(22) Filed: Feb. 13, 2026

(30) Foreign Application Priority Data
Feb. 18, 2025 (EP) 25158586.5

(51) Int. Cl. D06F 39/40; B41J 2/01; B41J 11/00; F22B 1/02; F22B 1/18; F22B 1/28; B41J 2/14

(52) U.S. Cl. CPC D06F 39/40; B41J 2/01; B41J 11/00216; B41J 11/0022; F22B 1/023; F22B 1/1815; F22B 1/28; B41J 2002/14491

(57) ABSTRACT

A hot steam generator including a thermally conductive and heatable body having at least one internal channel, each with a channel inlet and a channel outlet, into which a catching unit for catching carried-away water droplets is embedded, wherein a water supply to the channel inlet adjustable to a feed volume rate, and a heating device configured to heat the body to a temperature greater than or equal to 100°C.

### CROSS-REFERENCE TO RELATED APPLICATIONS

This application claims priority to European Patent Application No. 25158586.5 filed on February 18, 2025, which is incorporated by reference herein in its entirety.

### BACKGROUND OF THE DISCLOSURE

### Field of the Technology

The disclosure relates to a hot steam generator and a system for printing a substrate.

### Description of The Related Art

There are various possibilities for drying or fixing printing substrates. They can be thermally dried by heating a strip run. Infrared light can be used or hot air can be applied to the print substrate. Typical fixing devices usually have one or more hot blowers. Heat radiators or heating elements on the substrate guides are also conceivable. These serve to dry the printed-on primer and the printed-on ink and thus to fix it. Depending on the ink, UV radiators and other forms of fixing devices may also be provided. The fixing device is mounted downstream of the printing device in the printing direction or substrate running direction. A particularly efficient heat transfer can be achieved with superheated steam. Hot steam is particularly advantageous in the case of intermediate fixing when a printing substrate is to be printed on two sides.

In the fixing or drying of ink jet printing substrates, hot steam is required in order to be able to provide a sufficient quantity for the fixing process. This hot steam is generally generated by the external evaporation of deionized water and the subsequent conduction to a fixing unit or drying unit.

Hot steam refers to superheated steam, i.e. hot, saturated steam without condensation nuclei, and thus at least water in the gaseous state with a temperature at or above the boiling temperature of the water. The superheated steam is "dry" in this case, i.e. it does not contain any condensation nuclei or water droplets during application before impingement on the recording medium or substrate or the printing material of the simplex print image. In particular, therefore, wet steam with the designation hot steam is not included. However, water droplets may form on or after the hot vapor impinges on the recording medium or the printing material on the recording medium due to the interaction therewith.

Water droplets are liquid droplets of water having a temperature below the boiling point of water, for example 100° C, at normal pressure, which are in the form of a drop. In particular, it does not include water in solid form or in gas form.

The printed image is fixed, post-fixed or pre-fixed with hot steam. For this purpose, the unfixed or prefixed print image is exposed to hot, saturated steam without condensation nuclei for a certain time, for example for more than one (1) second. Over the length of the steam path, the method can be used for variable printing speeds and different types of recording media, for example different types of paper, cardboard or corrugated cardboard. Due to the high energy input of the hot steam due to the large condensation energy of water with respect to air, a very rapid intermediate fixing or post-fixing of the pressure image takes place. The hot steam allows heating without loss of moisture, so that, for example, glycol can penetrate better into the paper and film formation in a remaining ink layer is thereby promoted. During the intermediate fixing, contacts are formed between the individual printing material particles by the partial melting, whereby a complete melting of the printing material and an adhesion of the printing material to the recording medium are omitted in certain embodiments. A partially fixed printing material is formed on the recording medium, which in certain embodiments does not adhere to the recording medium after the intermediate fixing. In particular, no homogeneously fused layer of printing material is formed on the recording medium.

In known ink jet printing systems, the deionized water is heated electrically in a large boiler until it evaporates. The amount of steam is regulated by the heating force. On the one hand, these boilers are too large to be integrated into the fixing unit, and on the other hand, it is so hot during fixing that the water in the boiler would evaporate even without the built-in heater. It would therefore no longer be possible to control the amount of steam. For this reason, the boilers are usually arranged outside the drying unit and the superheated steam must be fed into the drying unit via pipes and hoses.

In addition, a maximum temperature of about 100°C can be achieved with an open atmospheric boiler. When the hot steam subsequently comes into contact with colder surfaces, which is usually the case with pipes, a part of the hot steam condenses again and must be passed back into the boiler as a drop of water.

Overpressure evaporators can reach higher steam temperatures, but they are up to ten times more expensive than atmospheric evaporators due to the costs of safety technology for overpressure systems.

### SUMMARY OF THE DISCLOSURE

We are looking for a solution to alleviate or overcome the above problems.

The disclosure relates to a hot steam generator and a printing device. Advantageous embodiments are specified in the dependent claims and in the following description.

The hot steam generator according to the disclosure has the following: a thermally conductive and heatable body having at least one internal channel, each with a channel inlet and a channel outlet, into which a catching means for catching carried-away water droplets is inserted; a water supply to the channel inlet that is adjustable to a supply volume velocity; a heating device adapted to heat the body to a temperature greater than or equal to 100°C.

The catching unit is preferably formed as a coil spring. However, other embodiments are conceivable like wires tensioned diagonally across the cross section of the channel.

In this hot steam generator, water can be guided into the at least one channel of a preheated body. This water is heated in the channel and evaporated. Due to the large volume expansion during evaporation, the steam is guided in the direction of the at least one channel outlet and escapes there as steam. At no time is there excess water in the hot area that could escape undesirably, since only as much water is supplied as is desired. Therefore, the hot environment in a prior art boiler is no longer a problem in this disclosure. The amount of hot steam produced can be regulated by a controlled supply of water. The temperature of the body has no influence on the amount of steam produced as long as it is higher than the boiling point of the water. For this reason, the hot steam generator can be arranged both inside a drying unit and outside a drying unit. A further advantage is the possible variation of the hot steam outlet temperature. In contrast, the hot steam temperature in atmospheric boiler evaporators is always around 100°C and corresponds to the boiling temperature of the water. With the hot steam generator according to the disclosure, which is based on flow, a temperature of the hot steam produced can be significantly higher than the boiling temperature of the water. All that is required is a suitable design of the channel surface in the channel system and sufficient heating capacity. The hot steam temperature can be controlled by the temperature of the body.

Initial tests with such hot steam generators at normal pressure did not show satisfactory results, since the rapidly expanding hot steam accelerated all remaining water droplets to such an extent that they did not come into contact with the channel walls and were therefore ejected as water droplets at the end of the channel. When ejected water droplets are impinged on the printed surface of the print medium, they reduce the amount of transferred energy and moisturize the medium. By adding a catching unit to the channel, which acts as a droplet brake, the "flying" water drops could be slowed down to such an extent that they evaporated completely before reaching the end of the channel. The result is droplet-free superheated steam at the end of the channel.

The disclosure has the advantage that the hot steam generator can be operated independently of the ambient temperature and can therefore be integrated into the drying unit. Furthermore, the hot steam generator can be designed so compact that it can be mounted in the drying unit in such a way that the need for steam guide lines, pipes or hoses between the hot steam generator and the drying unit is eliminated. Furthermore, the hot steam generator can produce superheated steam above the boiling temperature without operating at overpressure. This has significant security benefits. In addition, the hot steam generator according to the disclosure is very cost-efficient, since only a few components are required. For example, a level control which is necessary for boiler systems can be dispensed with.

In a particularly advantageous embodiment, the hot steam generator also has a control device which is set up to adjust the feed volume speed and/or a heating temperature of the body in such a way that a desired quantity and temperature of hot steam escapes from the channel outlet in each case. This is advantageous since an automated control is possible in this way. For this purpose, a temperature sensor and/or an electronic unit may be provided.

Embodiments may be designed as hardware (e.g. circuits), firmware, software or any combination thereof. Embodiments can also be implemented as instructions implemented on a machine-readable medium that can be read and executed by one or more processors. A machine-readable medium can handle any mechanism for storing or transmitting information in a form readable by a machine (e.g. a computer). For the purposes of this discussion, the terms "control unit", "control device" or "control device" are to be understood as circuits or processors or a combination thereof, including memories which store instructions. A circuit comprises an analogue circuit, a digital circuit, a data processing circuit, other structural electronic hardware or a combination thereof. A processor comprises a microprocessor, a digital signal processor (DSP), a central processor (CPU), an application-specific processor (ASIP) set by instructions; a graphics and/or image processor, a multi-core processor or other hardware processor.

The body preferably has a cylindrical shape, the at least one channel in particular having a helical shape. This is a particularly simple and energy-efficient construction.

In particular, the cross section of the coil spring fluctuates over its length. In this way, the escape of accelerated water droplets can be prevented even more effectively. It is also conceivable for the cross section to be constant or stepped over its length.

In a particularly advantageous embodiment, the cross section of the coil spring fluctuates between a total cross section of the channel and a portion of the total cross section of the channel, the portion being less than one third. In this way, as far as possible all water drops from the hot steam stream can be braked.

Preferably, the coil spring extends over a total length of the channel or a partial length which is preferably arranged at an end of the channel on the channel outlet side.

In particular, a channel cross section is between 3 mm and 2 cm. This is advantageous since in this way a particularly good heat transfer is possible.

According to the disclosure, a printing device with at least one printing unit for printing a substrate and with at least one drying unit for drying the printed substrate is also proposed, the drying unit having at least one hot steam generator according to one of the preceding claims, the at least one hot steam generator preferably being installed in a chamber of the drying unit. The printing device can be designed in particular as an ink jet printing device. A toner printing device is also conceivable. Typical printing devices for ink jet printing provide printing heads which are provided with ink ejection nozzles. As a rule, these are arranged above a substrate run and are arranged to eject ink onto a substrate. For better coagulation or solidification of the ink, it is furthermore possible to provide print heads for the application of a primer, which are arranged in front of the print heads for ink-jet printing in the printing direction. The primer can improve the coagulation by pretreating the surface, so that solidification in situ is contributed by avoiding separation or smearing of the ink by destabilization. It can increase the adhesion of the ink applied below, so that flaking or smearing of the ink is avoided. It can also regulate the absorption of the ink into the material and prevent the penetration of pigments and color particles into the material. It can also help the ink to dry on the surface more quickly.

### BRIEF DESCRIPTION OF THE DRAWINGS

Further embodiments are evident from the attached drawings and the following detailed description of the figures.

FIG. 1 shows a side sectional view of an embodiment of a hot steam generator according to the disclosure.

FIG. 2 shows a cross-sectional view of the embodiment of the hot steam generator according to the disclosure from FIG. 1.

FIG. 3 shows a perspective sectional view of the hot steam generator from FIGS. 1 and 2.

FIG. 4 shows a schematic side view of an embodiment of a printing device according to the disclosure.

### DESCRIPTION OF THE EMBODIMENTS

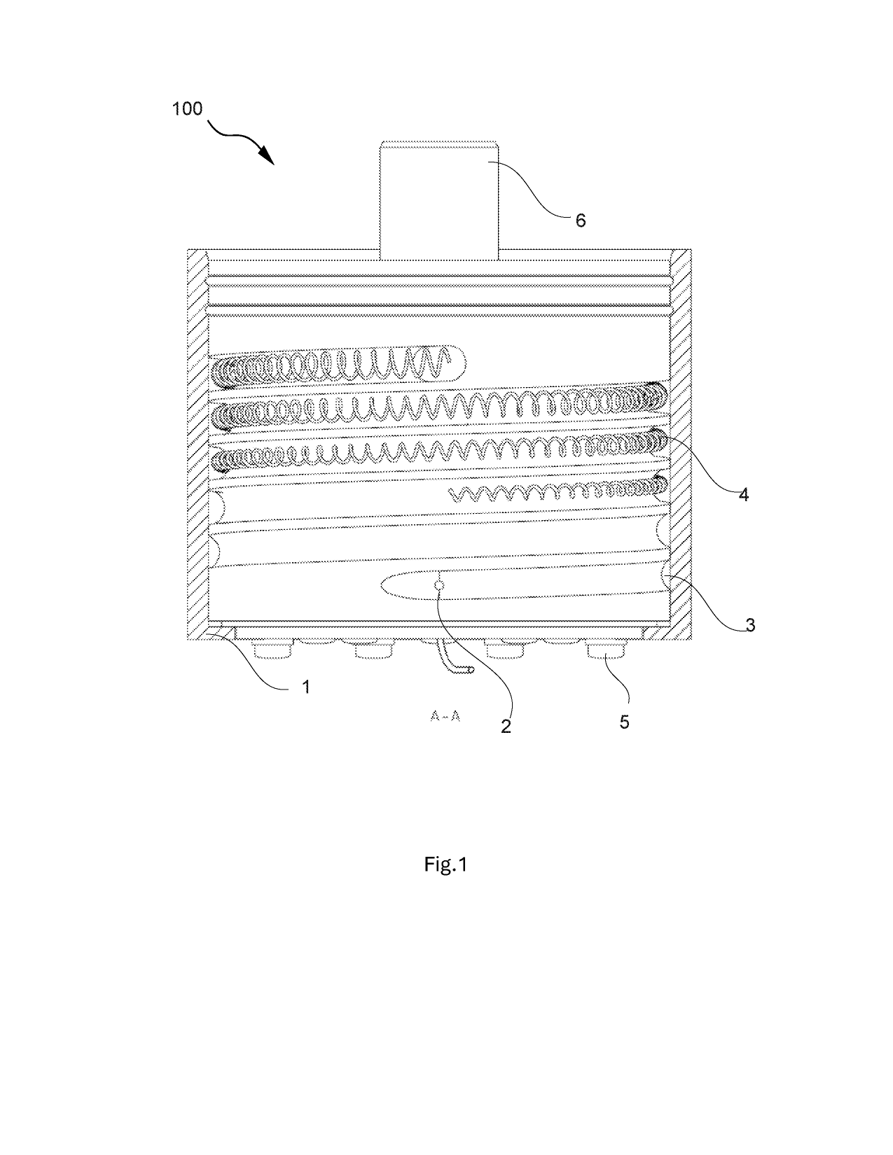

FIG. 1 shows a side sectional view of an embodiment of a hot steam generator according to the disclosure and is designated by 100.

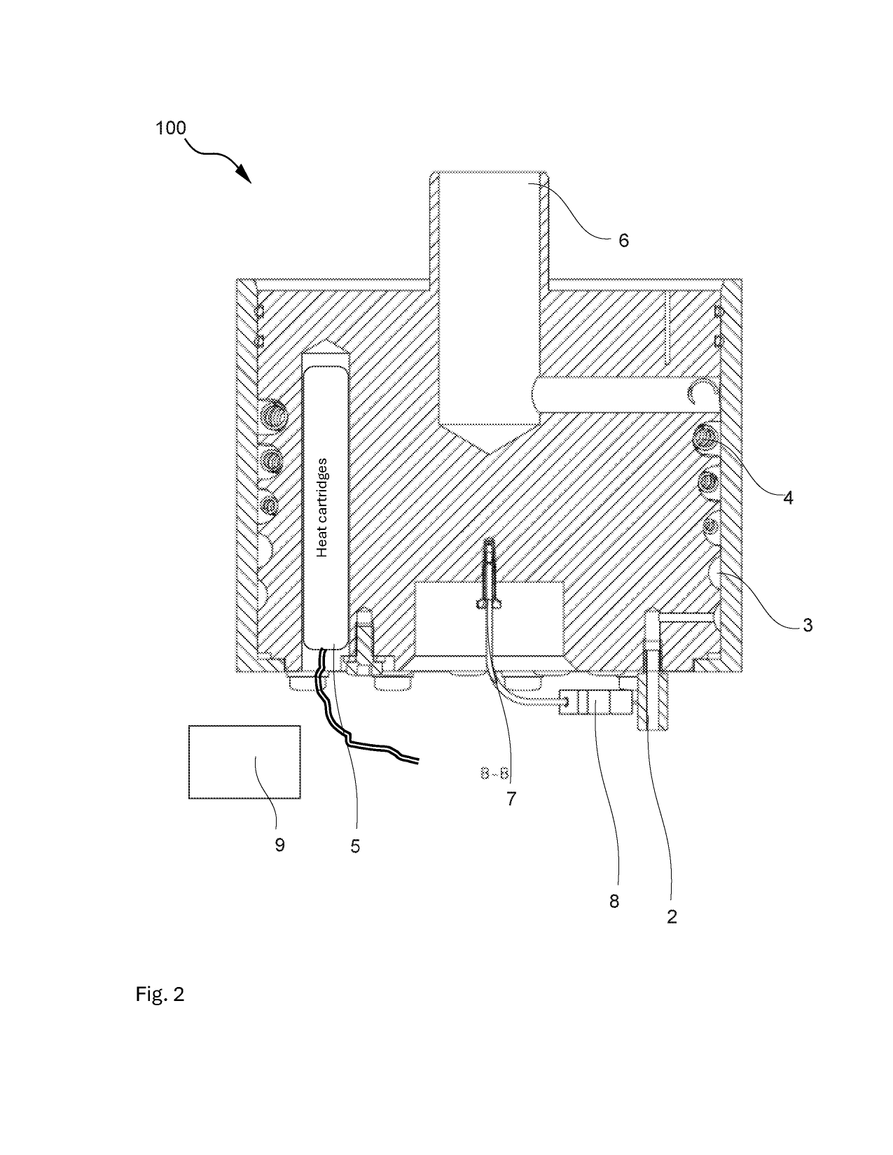

The hot steam generator 100 has a cylindrical body 1, which consists of a heatable thermally conductive material, preferably aluminium or iron. The latter has an internal channel 3 which has a channel inlet 2 and a channel outlet 6. The channel inlet 2 can be connected to a water supply that can be adjusted to a feed volume speed. A spiral spring 4 is let into the channel 3. Furthermore, a plurality of heating elements 5 (see FIG. 2) are let into cavities of the body.

By means of the heating elements 5, the entire body 1 can be heated to a temperature greater than or equal to a boiling temperature of the water. Water can be supplied through the channel inlet 2, which evaporates in the channel 3 through the heat of the heated body 1. Due to the volume expansion due to the evaporation, the hot steam continues in the channel 3 and can be heated further depending on the temperature of the body 1 and then escapes through the channel outlet 6. The entrainment of water drops during the volume expansion of the steam can be prevented or braked by the spiral spring 4.

FIG. 2 shows a cross-sectional view of the hot steam generator 100 of FIG. 1. Also a control device 9 is provided. In a particularly advantageous embodiment, the hot steam generator also has a control device 9 which is set up to adjust the feed volume speed and/or a heating temperature of the body in such a way that a desired quantity and temperature of hot steam escapes from the channel outlet in each case. This is advantageous since an automated control is possible in this way. For this purpose, a temperature sensor and/or an electronic unit may be provided. Embodiments may be designed as hardware (e.g. circuits), firmware, software or any combination thereof. Embodiments can also be implemented as instructions implemented on a machine-readable medium that can be read and executed by one or more processors. A machine-readable medium can handle any mechanism for storing or transmitting information in a form readable by a machine (e.g. a computer). For the purposes of this discussion, the terms "control unit", "control device" or "control device" are to be understood as circuits or processors or a combination thereof, including memories which store instructions. A circuit comprises an analogue circuit, a digital circuit, a data processing circuit, other structural electronic hardware or a combination thereof. A processor comprises a microprocessor, a digital signal processor (DSP), a central processor (CPU), an application-specific processor (ASIP) set by instructions; a graphics and/or image processor, a multi-core processor or other hardware processor.

By way of example, a heating cartridge is shown for the heating elements 5, which cartridge is embedded in a cavity. In addition, a temperature sensor 7 is shown which is arranged inside the body. The temperature sensor 7 is connected to a sensor plug 8, which is also connected to the channel inlet 2. The sensor plug 8 can be connected to a control unit.

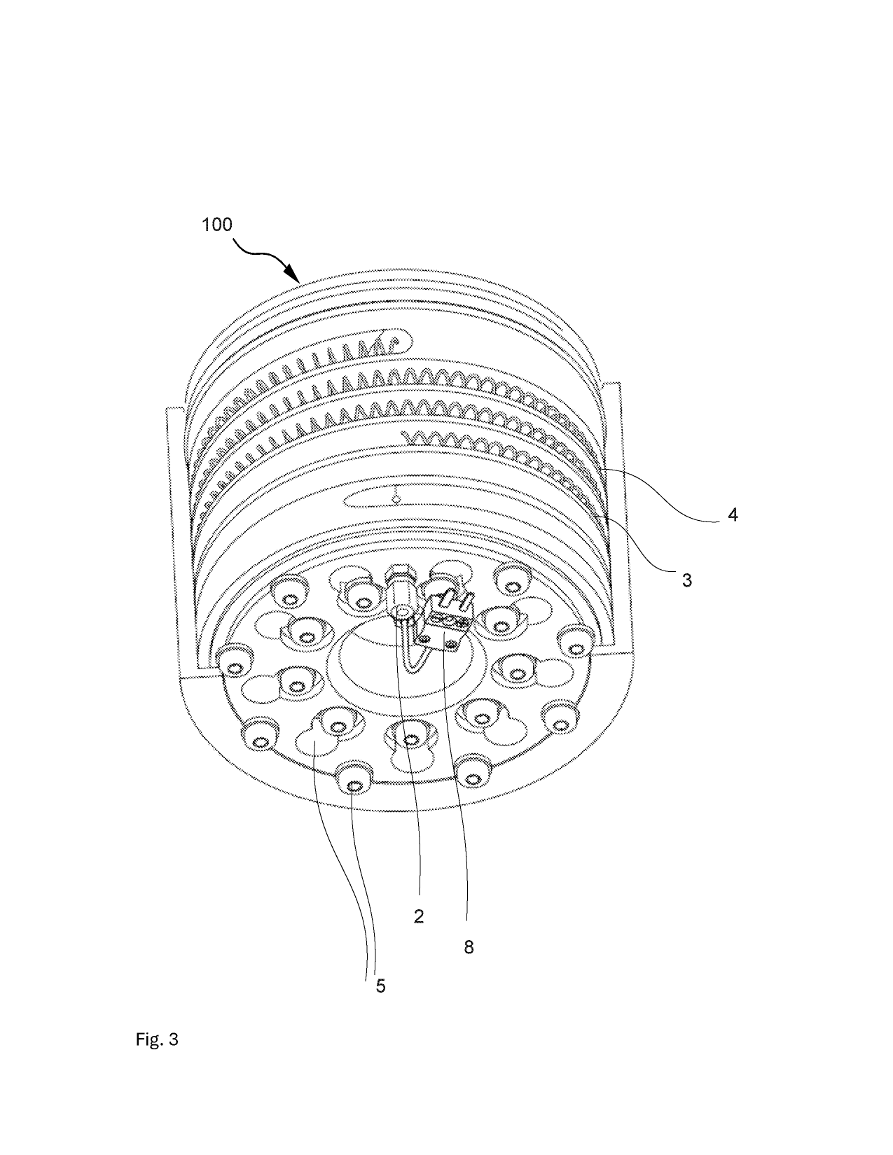

FIG. 3 shows the hot steam generator 100 of FIGS. 1 and 2 in a perspective view.

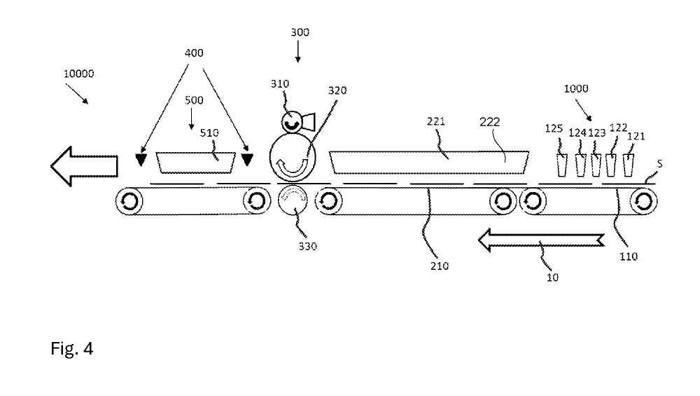

In FIG. 4, a system for ink jet printing is shown in a schematic side view and designated by 10000.

The system 10000 has a printing device 1000, a fixing device, a varnish applicator 300, a gloss sensor technology 400, and a varnish fixing device 500. A printing direction of the system is indicated by an arrow and denoted by 10.

The printing device 1000 here has a printing substrate transport device 110. The printing substrate transport device 100 here consists of two guide rollers on which an endless belt is guided. The printing substrate transport device is designed to transport or guide a substrate S among a number of print heads.

The print heads are arranged here in five print head modules. A first print head module 121 is arranged to apply primers to the substrate S. A second printhead module 122 is arranged to apply black ink to the substrate S. A third print head module 123 is arranged to apply cyan-colored ink to the substrate. A fourth printhead module 124 is arranged to apply magenta ink to the substrate. A fifth printhead module 125 is arranged to apply yellow ink to the substrate. The disclosure is not limited to the colors mentioned or to any order. Thus, a print head module for white ink or print head modules for further colors are conceivable.

The fixing device is located downstream of the printing device 1000 in the printing direction 10. The fixing device is set up to fix or dry the printed primer and the printed ink. For this purpose, a substrate fixing transport device 210 is provided here, which has two rollers and an endless belt in a manner comparable to the printing substrate transport device 110. Furthermore, one or more hot steam generators 221 with steam nozzles are provided in this embodiment. According to the disclosure , a printing device with at least one printing unit for printing a substrate and with at least one drying unit for drying the printed substrate is also proposed, the drying unit having at least one hot steam generator according to one of the preceding claims, the at least one hot steam generator preferably being installed in a chamber 222 of the drying unit. The printing device can be designed in particular as an ink jet printing device. A toner printing device is also conceivable. Typical printing devices for ink jet printing provide printing heads which are provided with ink ejection nozzles. As a rule, these are arranged above a substrate run and are arranged to eject ink onto a substrate. For better coagulation or solidification of the ink, it is furthermore possible to provide print heads for the application of a primer, which are arranged in front of the print heads for ink-jet printing in the printing direction. The primer can improve the coagulation by pretreating the surface, so that solidification in situ is contributed by avoiding separation or smearing of the ink by destabilization. It can increase the adhesion of the ink applied below, so that flaking or smearing of the ink is avoided. It can also regulate the absorption of the ink into the material and prevent the penetration of pigments and color particles into the material. It can also help the ink to dry on the surface more quickly.

In this embodiment, a varnish applicator 300 is provided downstream of the fixing device in the printing direction 10. However, embodiments without a varnish applicator 300 are also conceivable. The latter has an anilex roller 310 and a transfer roller 320. Furthermore, a varnish application device 300 is advantageously provided. This consists, for example, of a reservoir with a liquid tank, a pump or another mechanism. The reservoir can be filled with varnish. The anilex roller 310 can be sprayed with varnish, for example, or dipped into the varnish. The anilex roller 310 is arranged to apply a uniform layer of varnish to a transfer roller 320. When passing between the transfer roller 320 and a counter-pressure cylinder 330, the varnish is applied to the substrate S. The counter-pressure/impression cylinder 330 or the transfer roller 320 can be provided with a sleeve, which is pushed onto a mandrel and which can be designed as a so-called coating sleeve. A printing plate can be glued onto this sleeve.

A varnish fixing device 500 is arranged downstream of the varnish applicator 300 in the printing direction 10. A hot steam generator with a steam jet is also conceivable as the varnish fixing device 500. However, other fixing devices are also possible here. The gloss sensor system 400 is arranged upstream and downstream of the varnish fixing device 500. The varnish fixing device 500 is here in the form of one or more heat radiators 510. The varnish sensor system 400 is designed to detect gloss values resolved in the width direction and in the length direction.

1. A hot steam generator comprising:
a thermally conductive and heatable body having at least one internal channel with a channel inlet and a channel outlet, into which a catching unit configured to catch carried-away water droplets is let,
a water supply to the channel inlet that is adjustable by a control mechanism to a supply volume velocity; and
a heating device configured to heat the body to a temperature greater than or equal to 100°C.

2. The hot steam generator according to claim 1, further comprising control device arranged to adjust at least one of the feed volume velocity and a heating temperature of the body such that a desired amount and temperature of hot steam escapes from the channel outlet.

3. The hot steam generator according to claim 1, wherein the body has a cylindrical shape.

4. The hot steam generator of claim 3, wherein the at least one channel has a helical shape.

5. The hot steam generator according to claim 1, wherein the catching unit is formed as a coil spring or as at least one diagonally tensioned wire.

6. The hot steam generator according to claim 5, wherein the cross-section of the coil spring fluctuates along its length or wherein the cross-section of the coil spring is constant along its length or wherein the cross-section of the coil spring is stepped along its length.

7. The hot steam generator according to claim 6, wherein the cross-section of the coil spring fluctuates between a total cross-section of the channel and a portion of the total cross-section of the channel.

8. The hot steam generator according to claim 5, wherein the coil spring extends over a total length of the channel or wherein the coil spring extends over a partial length of the channel and located at the channel outlet of the channel.

9. The hot steam generator according to claim 1, wherein a channel cross section is between 3 mm and 2 cm.

10. A system for printing on a substrate comprising:
at least one printing unit configured to print on a substrate; and
at least one drying unit configured to dry the printed substrate, the drying unit including at least one of the hot steam generator according to claim 1.

11. The system according to claim 10, wherein the system is an ink jet printing device, wherein the at least one hot steam generator is installed in a chamber of the drying unit.
